(19) United States
(12) Patent Application Publication
(10) Pub. No.: US 2016/0315886 A1
(43) Pub. Date: Oct. 27, 2016

(54) NETWORK INFORMATION PUSH METHOD, APPARATUS AND SYSTEM BASED ON INSTANT MESSAGING

(71) Applicant: TENCENT TECHNOLOGY (SHENZHEN) COMPANY LIMITED, Shenzhen (CN)

(72) Inventor: Xiaoming HUANG, Shenzhen (CN)

(73) Assignee: TENCENT TECHNOLOGY (SHENZHEN) COMPANY LIMITED, Shenzhen (CN)

(21) Appl. No.: 15/199,243

(22) Filed: Jun. 30, 2016

Related U.S. Application Data
(63) Continuation of application No. PCT/CN2015/082147, filed on Jun. 24, 2015.

(30) Foreign Application Priority Data
Jun. 24, 2014 (CN) 201410289498.8

(51) Int. Cl. H04L 12/58; G06K 9/00; H04L 29/08

(52) U.S. Cl. CPC H04L 51/046; H04L 67/306; H04L 67/26; G06K 9/00288; H04M 1/72555

(57) ABSTRACT

A network information push method, apparatus, and system based on instant messaging are disclosed. The method includes: acquiring a user identifier and video data corresponding to the user identifier; detecting a face image in the video data; determining a user gender according to the face image; searching for corresponding network information according to the determined user gender; and sending the network information to an instant messaging chat window, which corresponds to the user identifier, for presentation. By using the method, apparatus, and system, network information can be pushed according to a user gender, and the pushed network information better conforms to needs of a user, thereby reducing redundancy of network information and a waste of network resources.

### CROSS REFERENCE TO RELATED APPLICATION

This application is a continuation application of International Application No. PCT/CN2015/082147, titled “NETWORK INFORMATION PUSH METHOD, APPARATUS, AND SYSTEM BASED ON INSTANT MESSAGING”, filed on Jun. 24, 2015, which claims priority to Chinese Patent Application No. 201410289498.8, filed on Jun. 24, 2014, both of which are hereby incorporated by reference in their entirety.

### TECHNICAL FIELD

The present disclosure relates to the field of computer technologies, and in particular, to a network information push method, apparatus, and system based on instant messaging.

### BACKGROUND

With the development of the Internet, a communication manner of people has changed a lot and instant messaging (IM) has been widely accepted and used on the Internet. In addition to presenting chat content, generally, an instant messaging chat window may further present some network information placed by a service provider, for example, version update information of instant messaging software, news information, or commodity information.

However, in the conventional technology, the service provider cannot push effective network information to two parties of instant messaging, and therefore, a great deal of network information that is presented in an instant messaging window cannot receive any response from a user, causing redundancy of network information. Meanwhile, push of a great deal of such “useless” network information also causes a waste of network resources.

### SUMMARY

In view of the above, a network information push method, apparatus, and system based on instant messaging are provided, which push effective network information, thereby reducing redundancy of network information and a waste of network resources.

A network information push method based on instant messaging is provided. The method being performed in an instant messaging client, the instant messaging client including a storage device, one or more processors, and program instructions stored in the storage device and executed by the one or more processors, the method including:
acquiring a user identifier of a user that logs onto the instant messaging client, and acquiring video data corresponding to the user identifier;
detecting a face image in the video data;
determining a user gender according to the face image;
searching for network information corresponding to the user gender according to the determined user gender; and
sending the network information to an instant messaging chat window, which corresponds to the user identifier, for presentation.

A network information push method based on instant messaging, the method including:
establishing video instant messaging between a first instant messaging client and a second instant messaging client;
acquiring a first user identifier used for logging onto the first instant messaging client and corresponding first video data, and sending the first video data to the second instant messaging client for displaying;
detecting a face image in the first video data;
determining a user gender corresponding to the first user identifier according to the face image;
searching for corresponding network information according to the user gender corresponding to the first user identifier; and
sending the found network information to the first instant messaging client for presentation.

A network information push apparatus based on instant messaging, the apparatus including:
an information acquiring module, configured to acquire a user identifier of a user that logs onto an instant messaging client, and acquire video data corresponding to the user identifier;
a face detection module, configured to detect a face image in the video data;
a gender determining module, configured to determine a user gender according to the face image;
an information search module, configured to search for network information corresponding to the user gender according to the determined user gender; and
an information push module, configured to send the network information to an instant messaging chat window, which corresponds to the user identifier, for presentation.

A network information push system based on instant messaging, the system including:
an instant messaging server, configured to establish video instant messaging between a first instant messaging client and a second instant messaging client, acquire a first user identifier used for logging onto the first instant messaging client and corresponding first video data, and send the first video data to the second instant messaging client for displaying;
a gender detection server, configured to detect a face image in the first video data, and determine a user gender corresponding to the first user identifier according to the face image; and
an information push server, configured to search for corresponding network information according to the user gender corresponding to the first user identifier, and send the found network information to the first instant messaging client for presentation.

According to the foregoing network information push method, apparatus, and system based on instant messaging, when two parties of instant messaging have a video chat, a face image in video data is detected, a user gender is determined according to the face image, and then, corresponding network information is searched for according to the user gender, so as to push network information according to the user gender. The pushed network information better conforms to needs of a user, thereby reducing redundancy of network information and a waste of network resources.

### BRIEF DESCRIPTION OF THE DRAWINGS

FIG. 1 is a system architecture diagram of running of a network information push method based on instant messaging according to an embodiment;

FIG. 2 is a schematic flowchart of a network information push method based on instant messaging according to an embodiment;

FIG. 3 is a schematic flowchart of a network information push method based on instant messaging according to another embodiment;

FIG. 4 is a diagram of an application environment of a network information push method based on instant messaging according to an embodiment;

FIG. 5 is a structural block diagram of a network information push apparatus based on instant messaging according to an embodiment;

FIG. 6 is a structural block diagram of a gender determining module in FIG. 5; and

FIG. 7 is a schematic structural diagram of a network information push system based on instant messaging according to an embodiment.

### DETAILED DESCRIPTION OF THE EMBODIMENTS

To make the objectives, technical solutions, and advantages of the present disclosure clearer, the present disclosure is further described in detail below with reference to the accompanying drawings and embodiments. It should be understood that, the specific embodiments described herein are merely for explaining the present disclosure, but are not intended to limit the present disclosure.

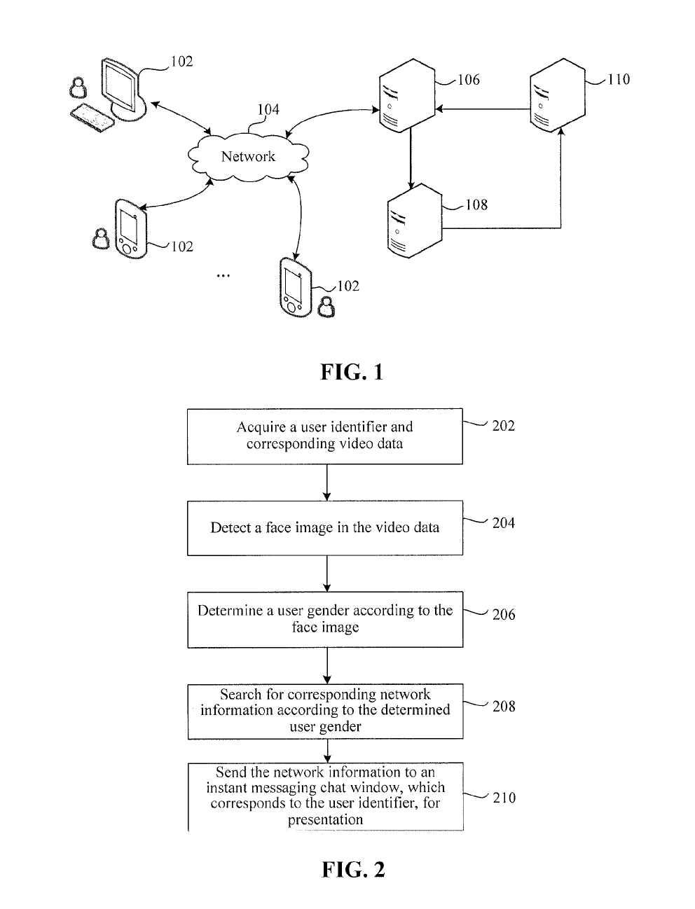

This embodiment of the present invention provides a network information push method based on instant messaging, which may be applied to a system shown in FIG. 1. Referring to FIG. 1, various terminals 102 perform instant messaging through a network 104. The terminal 102 may be any device capable of running an instant messaging client, such as a personal computer, a personal digital assistant, a notebook computer, a tablet computer, or a smart phone. A user can log onto an instant messaging client by using the terminal 102, and an instant messaging message is sent to an instant messaging server 106 through the network 104, and after receiving the instant messaging message, the instant messaging server 106 sends, through the network 104, the instant messaging message to another terminal that performs instant messaging with the terminal 102. The instant messaging message includes, but is not limited to a text message, a picture message, a multimedia message, or the like.

Further, video instant messaging may further be performed between terminals 102, for example, a user A uses the terminal 102 to log onto the instant messaging client and perform instant messaging with a user B of another terminal 102. The user A may send a video chat request to the user B by using the instant messaging client, and the request is forwarded to the another terminal 102 by using the instant messaging server 106. After the user B of the another terminal 102 confirms that the request is accepted, the two parties establish a video chat, each terminal 102 uses a built-in video capture device to capture a video image, and then sends the captured video image to the other party by using the instant messaging server 106. For example, the video capture device of the terminal 102 of the user A captures a video image of the user A, and sends the video image to the instant messaging server 106 through the network 104; the instant messaging server 106 then sends, through the network 104, the video image of the user A to the another terminal 104 of the user B for displaying. Similarly, a video image of the user B may also be sent to the terminal 102 of the user A for displaying, thereby implementing a video chat.

Further, a gender detection server 108 may process the video data received by the instant messaging server 106, which includes detecting a face image in the video data and determining a user gender according to the face image, for example, detecting the video image of the user A to determine the gender of the user A. The determined user gender and a corresponding user identifier are sent to an information management server 110. The information management server 110 stores a large quantity of network information that can be pushed, and may update the stored network information periodically. The network information includes but is not limited to version update information of various software, news information, commodity information, and the like. After receiving the user identifier and user gender, the information management server 110 searches for network information matching the user gender by using the user gender as a keyword, and the matching network information and the corresponding user identifier are sent to the instant messaging server 106 together. The instant messaging server 106 receives the network information and the user identifier, and according to the user identifier, sends the network information to an interface of an instant messaging client run in the corresponding terminal 102 for displaying. In this way, effective network information can be placed on an instant messaging client, thereby reducing redundancy of network information and a waste of network resources.

As shown in FIG. 2, in an embodiment, a network information push method based on instant messaging is provided, and the method includes:

Step 202: Acquire a user identifier and video data corresponding to the user identifier.

In this embodiment, two terminals that establish a video chat send video data acquired by video capture devices and corresponding user identifiers to an instant messaging server together in real time. Therefore, a user identifier and corresponding video data may be acquired from the instant messaging server. Specifically, in an embodiment, the step of acquiring a user identifier and corresponding video data includes: acquiring a user identifier used by a user to log onto the instant messaging client, and corresponding video data, where the video data is video data that needs to be sent to another instant messaging client, which establishes video instant messaging with the instant messaging client, for displaying.

Step 204: Detect a face image in the video data.

Specifically, one of multiple face detection methods, such as a reference template method, a face rule method, a sample learning method, and a skin color model method, may be used to detect whether the video data includes a face image. By using the face rule method as an example, because a face has particular structure distribution features, these features may he extracted from video data to generate a corresponding rule to determine whether the video data includes a face. By using the skin color model method as an example, because the skin color of a face is relatively concentrated in color space and is regular in some extent, it may be detected whether video data includes a face by detecting whether the video data includes skin color features of a face.

In this embodiment, in step 204, if it is detected that the video data includes a face image, step 206 is performed; otherwise, detection continues.

Step 206: Determine a user gender according to the face image.

After the face image is detected, the detected face image may be preprocessed, for example, setting the face image to unified dimensions and normalizing illuminance. Then, features are extracted from the preprocessed face image, and the user gender is determined according to the extracted features.

Step 208: Search for corresponding network information according to the determined user gender.

Users of different genders may be interested in different network information, for example, a male user may be interested in network information related to software, football, vehicle parts, and the like, while a female user may be interested in network information related to cosmetics, bags, clothing, and the like. Therefore, the user gender may be used as a keyword to search a large amount of network information for network information that matches the gender.

Step 210: Send the found network information to an instant messaging chat window, which corresponds to the user identifier, for presentation.

In this embodiment, the user identifier may be an instant messaging number used for logging onto the instant messaging client, a mobile communication number or a unique identity number corresponding to the instant messaging number uniquely, or the like. The user gender of a user is determined according to the video data acquired by the video capture device of the terminal used by the user. In this way, the network information found according to the user gender may be pushed to the terminal used by the user. Specifically, the network information may be presented in the instant messaging chat window used for the video chat.

In this embodiment, when two parties of the instant messaging have a video chat, a face image in video data is detected, a user gender is determined according to the face image, and then, corresponding network information is searched for according to the user gender, so as to push network information according to the user gender. The pushed network information better conforms to needs of a user, thereby reducing redundancy of network information and a waste of network resources.

In an embodiment, step 206 of determining a user gender according to the face image includes: extracting features from the face image, and inputting the extracted features to a preset classification model, so as to obtain a user gender classification result, where the preset classification model is a classification model obtained by using a support vector machine to perform classification training on features extracted from face image training samples.

In this embodiment, gender classification of a face image by using a classification model is divided into two parts: an offline part and an online part. In the offline part, multiple face images of different degrees, including male face images and female face images, may be selected as face image training samples. These face image training samples may be marked as male/female manually first, that is, each face image training sample is marked as male or female according to an actual gender of the face image. Then, features are extracted from these face image training samples. Before features are extracted, scales and illuminance of the face images may be normalized first, for example, widths and heights of the face images are unified to be 80*80 pixels, a mean value of pixel values is 0, and square errors of pixel values are normalized to be 1. Further, features of the normalized face images are extracted. For example, any one of feature extractors such as Gabor (an image texture feature extractor), LBP (local binary pattern, which is an efficient texture descriptor), and HOG (Histogram of Oriented Gradient) may be used to extract features from the face images. By using Gabor features as an example, a convolution operation may be performed on the normalized face images and a Gabor filter of multiple scales and multiple directions, to obtain a multidimensional feature coefficient. For example, a convolution operation is performed on the face images with normalized dimensions of 80*80 pixels and a Gabor filter of five scales and eight directions, to obtain a Gabor feature coefficient with 80*80*5*8 dimensions. Because the dimensions of the Gabor feature coefficient obtained at this time is excessively high, feature dimension reduction is performed on the obtained multidimensional feature coefficient. A principal component analysis method may be used to reduce the dimensions of the Gabor feature coefficient, for example, to 6400 dimensions. The feature coefficient obtained after the dimension reduction is input as x, and correspondingly marked gender scores output as y, and regression fitting is performed on fin y=f(x), to produce a scoring model. By means of parameter optimization, an optimum linear fitting model Y=F(X) (that is, the classification model) is obtained.

In the online part, after a face image in each piece of video data received by the instant messaging server is detected, the detected face image may be normalized correspondingly, and corresponding features of the normalized face image may be extracted. By using Gabor features as an example, a Gabor feature coefficient may be correspondingly extracted from the normalized face image and dimension reduction is performed on the Gabor feature coefficient. The feature coefficient obtained after the dimension reduction is input as X to the foregoing obtained linear fitting model F, an operation is performed, and a gender scoring result Y corresponding to the feature X is output. According to the gender scoring result Y, the user gender corresponding to the face image may be obtained.

In this embodiment, by using a support vector machine to perform classification training on face image samples, a classification model is obtained. Corresponding features in a face image detected in video data received by an instant messaging server in real time may be correspondingly extracted, and directly input to a classification model that is trained in advance, and a corresponding scoring result may be obtained quickly, thereby obtaining a user gender corresponding to the video data quickly, which is implemented conveniently and quickly.

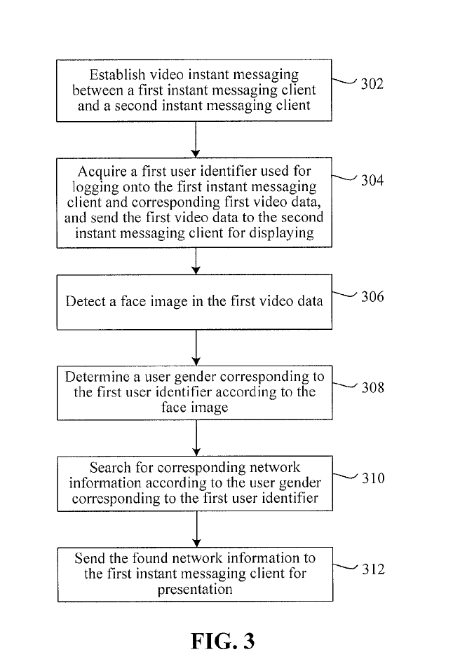

As shown in FIG. 3, in another embodiment, another network information push method based on instant messaging is further provided and the method includes:

Step 302: Establish video instant messaging between a first instant messaging client and a second instant messaging client.

In this embodiment, the terms “first” and “second” are relative concepts. The second instant messaging client refers to another client that is run in a terminal different from that of the first instant messaging client and performs instant messaging with the first instant messaging client. A first user may use a first user identifier to log onto the first instant messaging client on a first terminal, and a second user may use a second user identifier to log onto the second instant messaging client on a second terminal.

Specifically, a terminal where the first instant messaging client is located may initiate a video chat request, and after receiving a confirmation message from the second terminal, establish video instant messaging, that is, a video chat, between the first instant messaging client and the second instant messaging client. A terminal where the second instant messaging client is located may also initiate a video chat request, and after receiving a confirmation message from the first terminal, establish a video chat between the first instant messaging client and the second instant messaging client.

Step 304: Acquire a first user identifier used for logging onto the first instant messaging client and corresponding first video data, and send the first video data to the second instant messaging client for displaying.

In this embodiment, in an instant messaging server, the first user identifier and the second user identifier may be friends or members in a same group. After the video chat between the first instant messaging client and the second instant messaging client is established, the first terminal may use a video capture device to acquire the first video data of the first user and send the first video data to the second instant messaging client for displaying. In this way, the second user may see a video image of the first user in real time. Similarly, the second terminal may also use a video capture device to acquire the second video data of the second user and send the second video data to the first instant messaging client for displaying.

Step 306: Detect a face image in the first video data.

While sending the first video data to the instant messaging server, the first terminal also sends, to the instant messaging server, the first user identifier used for logging onto the first instant messaging client and uniquely identifying the first user. With reference to FIG. 1, a gender detection server may acquire from the instant messaging server, the first user identifier and the corresponding first video data, and detect whether the first video data includes a face image. If it is detected that the first video data includes the face image, step 308 is further performed, and if the first video data does not include a face image, no processing is performed or network information may be selected randomly and pushed. As described above, one of multiple face detection methods, such as a reference template method, a face rule method, a sample learning method, and a skin color model method, may be used to detect whether the video data includes a face image.

Step 308: Determine a user gender corresponding to the first user identifier according to the face image.

As described above, after the face image is detected, the detected face image may be preprocessed, for example, setting the face image to unified dimensions and normalizing illuminance. Then, features are extracted from the preprocessed face image, and the user gender is determined according to the extracted features.

In an embodiment, features may be extracted from the normalized face image, and the extracted features are input to a preset classification model, so as to obtain a user gender classification result, where the preset classification model is a classification model obtained by using a support vector machine to perform classification training on features extracted from face image training samples.

Step 310: Search for corresponding network information according to the user gender corresponding to the first user identifier.

The user gender includes male and female, and may be used as a keyword to search a large amount of network information for network information that matches the gender.

Step 312: Send the found network information to the first instant messaging client for presentation.

The user gender determined according to the first video data is the gender of the first user and corresponds to the first user identifier. According to the first user identifier, the found network information may be sent to the first instant messaging client for presentation. The first user may interact with the network information presented on the first instant messaging client.

In this embodiment, when two parties of the instant messaging have a video chat, a face image in video data is detected, a user gender is determined according to the face image, and then corresponding network information is searched for according to the user gender, so as to push network information according to the user gender. The pushed network information better conforms to needs of a user, thereby reducing redundancy of network information and a waste of network resources.

In an embodiment, after step 302 of establishing video instant messaging between a first instant messaging client and a second instant messaging client, the method further includes: acquiring a second user identifier for logging onto the second instant messaging client and corresponding second video data, and sending the second video data to the first instant messaging client for displaying; detecting a face image in the second video data; determining a user gender corresponding to the second user identifier according to the face image; searching for corresponding network information according to the user gender corresponding to the second user identifier; and sending the found network information to the second instant messaging client for presentation.

In this embodiment, the second video data of the second user may further be acquired, so as to obtain the user gender of the second user, thereby pushing network information to the second user according to the user gender of the second user.

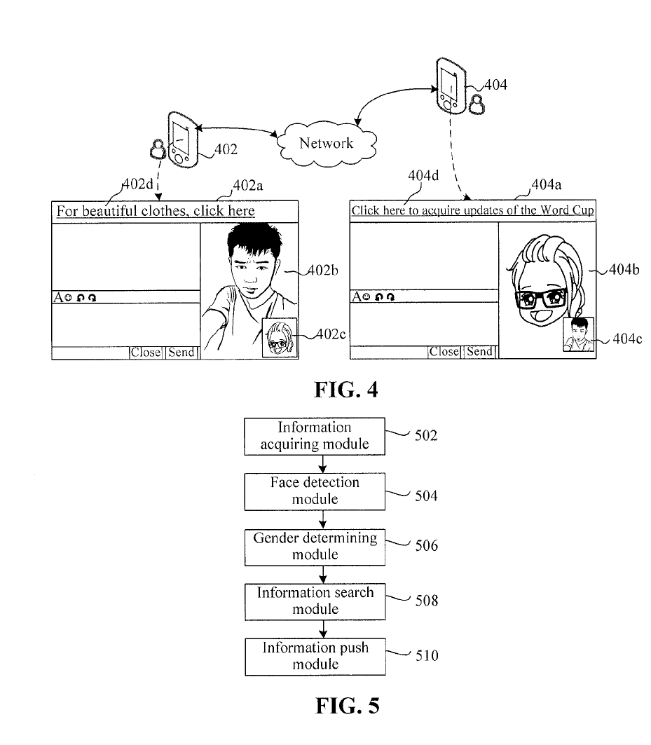

With reference to FIG. 4, description is made by using an example in which a first terminal 402 and a second terminal 404 perform instant messaging. It may be understood that, the embodiment shown in FIG. 4 is merely a simple embodiment used for describing a network information push method based on instant messaging provided by this embodiment of the present invention. In this embodiment, the first terminal 402 interacts with the second terminal 404 through a network. Although FIG. 4 merely shows a network, it may also he understood that, data sent by the first terminal 402 to the second terminal 404 is forwarded by a server. With reference to FIG. 1, the server includes an instant messaging server, a gender detection server, and an information management server.

As shown in FIG. 4, a first user uses a first user identifier to log onto a first instant messaging client on the first terminal 402, and a first instant messaging chat window 402a is displayed on the first terminal 402. A second user uses a second user identifier to log onto a second instant messaging client on the second terminal 404, and a second instant messaging chat window 404a is displayed on the second terminal 404. The first user and the second user perform instant messaging by using the instant messaging chat windows. For example, the first terminal 402 may send, to the second terminal 404 by using an instant messaging server, an instant messaging message that is input by the first user, and the instant messaging message input by the first user is displayed in the second instant messaging chat window 404a. Further, the first user may have a video chat with the second user. The first terminal 402 may capture first video data of the first user by using a video capture device, and then sends the first user identifier and the first video data to the instant messaging server; the instant messaging server then sends the first video data to the second terminal 404, and the first video data is displayed in the second instant messaging chat window 404a. Similarly, second video data of the second user is also sent to the first terminal 402 and displayed in the instant messaging chat window 402a. As shown in FIG. 4, the first instant messaging chat window 402a displays a video image 402b of the second user. Certainly, the first instant messaging chat window 402a may also display a video image 402c of the first user. The second instant messaging chat window 404a displays a video image 404b of the first user. Certainly, the second instant messaging chat window 404a may also display a video image 404c of the second user. Therefore, the video image 402b is actually an image the same as the video image 404c, and the video image 404b is actually an image the same as the video image 402c. In this way, a video chat between the first user and the second user is implemented.

Further, the gender detection server acquires video data (which corresponds to the video image) of the first user, detects a face image therein, and determines the gender of the first user according to the face image; and acquires video data of the second user, detects a face image therein, and determines the gender of the second user according to the face image. In this embodiment, the gender detection server determines that the first user is female and the second user is male. The gender detection server delivers the determined user gender and the corresponding user identifier to the information management server. The information management server searches according to the user gender, to obtain network information matching the user gender, and then sends the network information and the corresponding user identifier to the instant messaging server. The instant messaging server pushes corresponding network information to the corresponding terminal according to the user identifier, and the network information is displayed in the instant messaging chat window. The instant messaging chat window may directly display the network information, which includes, but is not limited to a text, a picture, and the like. Alternatively, the information management server may generate a link corresponding to the network information. In this case, in addition to presenting the text and picture, the instant messaging chat window may further present the corresponding link. As shown in FIG. 4, network information 402d presented in the first instant messaging chat window 402a used by the first user is “for beautiful clothes, click here”. The information corresponds to a link address and the first user may click the link to go to a corresponding webpage to learn about details of the network information. When network information 404d presented in the second instant messaging chat window 404a used by the second user is “click here to acquire updates of the Word Cup”, the second user may also interact with the network information.

As shown in FIG. 5, in an embodiment, a network information push apparatus based on instant messaging is further provided and the apparatus includes:
an information acquiring module 502, configured to acquire a user identifier and corresponding video data;
a face detection module 504, configured to detect a face image in the video data;
a gender determining module 506, configured to determine a user gender according to the face image;
an information search module 508, configured to search for corresponding network information according to the determined user gender; and
an information push module 510, configured to send the network information to an instant messaging chat window, which corresponds to the user identifier, for presentation.

In an embodiment, the information acquiring module 502 is configured to acquire a user identifier used for logging onto an instant messaging client and corresponding video data, where the video data is video data that needs to be sent to another instant messaging client, which establishes video instant messaging with the instant messaging client, for displaying.

Further, as shown in FIG. 6, in an embodiment, the gender determining module 506 includes:
a feature extraction module 516, configured to extract features from the face image; and
a gender detection module 526, configured to input the extracted features to a preset classification model, so as to obtain a user gender classification result.

In this embodiment, the classification model is a classification model obtained by using a support vector machine to perform classification training on features extracted from face image training samples.

In an embodiment, the gender determining module 506 further includes a preprocessing module (not shown in the figure), which is configured to preprocess the detected face image, for example, setting the face image to unified dimensions and normalizing illuminance, and then, extract features from the preprocessed face image.

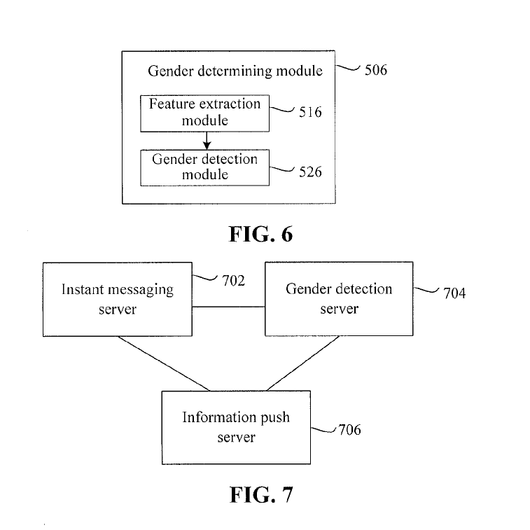

As shown in FIG. 7, in an embodiment, a network information push system based on instant messaging is further provided and the system includes:
an instant messaging server 702, configured to establish video instant messaging between a first instant messaging client and a second instant messaging client, acquire a first user identifier used for logging onto the first instant messaging client and corresponding first video data, and send the first video data to the second instant messaging client for displaying;
a gender detection server 704, configured to detect a face image in the first video data, and determine a user gender corresponding to the first user identifier according to the face image; and
an information push server 706, configured to search for corresponding network information according to the user gender corresponding to the first user identifier, and send the found network information to the first instant messaging client for presentation.

Further, in an embodiment, the instant messaging server 702 is further configured to acquire a second user identifier used for logging onto the second instant messaging client and second video data corresponding to the second user identifier, and send the second video data to the first instant messaging client for displaying.

The gender detection server 704 is further configured to detect a face image in the second video data, and determine user gender corresponding to the second user identifier according to the face image.

The information push server 706 is further configured to search for corresponding network information according to the user gender corresponding to the second user identifier, and send the found network information to the second instant messaging client for presentation.

Further, in an embodiment, the gender detection server 704 is configured to normalize the detected image.

A person of ordinary skill in the art may understand that all or some of the processes of the methods in the foregoing embodiments may be implemented by a computer program instructing relevant hardware. The program may be stored in a computer readable storage medium. When the program is executed, processes of the embodiments of the foregoing methods may be included. The storage medium may be a magnetic disk, an optical disc, a read-only memory (ROM), a random access memory (RAM), or the like.

The foregoing embodiments only describe several implementation manners of the present disclosure, and the description is specific and detailed, but cannot therefore be understood as a limitation to the patent scope of the present disclosure. It should be noted that a person of ordinary skill in the art may further make variations and improvements without departing from the conception of the present disclosure, and these all fall within the protection scope of the present disclosure. Therefore, the patent protection scope of the present disclosure should be subject to the appended claims.

1. A network information push method based on instant messaging, performed on an instant messaging client, the instant messaging client comprising a non-volatile storage device, one or more processors, and program instructions stored in the non-volatile storage device and executed by the one or more processors, the method comprising:
acquiring a user identifier of a user that logs onto the instant messaging client, and acquiring video data corresponding to the user identifier;
detecting a face image in the video data;
determining a user gender according to the face image;
searching for network information corresponding to the user gender according to the determined user gender; and
sending the network information to an instant messaging chat window, which corresponds to the user identifier, for presentation.

2. The method according to claim 1, wherein the video data is video data that needs to be sent to another instant messaging client, which establishes video instant messaging with the instant messaging client, for displaying.

3. The method according to claim 1, wherein the step of determining a user gender according to the face image comprises:
extracting features from the face image, and inputting the extracted features to a preset classification model, to obtain a user gender classification result.

4. The method according to claim 3, wherein the preset classification model is obtained by using a support vector machine to perform classification training on features extracted from face image training samples.

5. A network information push method based on instant messaging, the method comprising:
establishing video instant messaging between a first instant messaging client and a second instant messaging client;
acquiring a first user identifier used for logging onto the first instant messaging client and corresponding first video data, and sending the first video data to the second instant messaging client for displaying;
detecting a face image in the first video data;
determining a user gender corresponding to the first user identifier according to the face image;
searching for network information corresponding to the first user identifier according to the user gender corresponding to the first user identifier; and
sending the network information to the first instant messaging client for presentation.

6. The method according to claim 5, after the step of establishing video instant messaging between a first instant messaging client and a second instant messaging client, further comprising:
acquiring a second user identifier used for logging onto the second instant messaging client and corresponding second video data, and sending the second video data to the first instant messaging client for displaying;
detecting a face image in the second video data;
determining a user gender corresponding to the second user identifier according to the face image;
searching for corresponding network information according to the user gender corresponding to the second user identifier; and
sending the found network information to the second instant messaging client for presentation.

7. A network information push apparatus based on instant messaging, the apparatus comprising:
an information acquiring module, configured to acquire a user identifier of a user that logs onto an instant messaging client, and acquire video data corresponding to the user identifier;
a face detection module, configured to detect a face image in the video data;
a gender determining module, configured to determine a user gender according to the face image;
an information search module, configured to search for network information corresponding to the user gender according to the determined user gender; and
an information push module, configured to send the network information to an instant messaging chat window, which corresponds to the user identifier, for presentation.

8. The apparatus according to claim 7, wherein the video data is video data that is sent to another instant messaging client, which establishes video instant messaging with the instant messaging client, for displaying.

9. The apparatus according to claim 7, wherein the gender determining module comprises:
a feature extraction module, configured to extract features from the face image; and
a gender detection module, configured to input the extracted features to a preset classification model, to obtain a user gender classification result.

10. The apparatus according to claim 9, wherein the preset classification model is obtained by using a support vector machine to perform classification training on features extracted from face image training samples.

11. A network information push system based on instant messaging, the system comprising:
an instant messaging server, configured to establish video instant messaging between a first instant messaging client and a second instant messaging client, acquire a first user identifier used for logging onto the first instant messaging client and corresponding first video data, and send the first video data to the second instant messaging client for displaying;
a gender detection server, configured to detect a face image in the first video data, and determine a user gender corresponding to the first user identifier according to the face image; and
an information push server, configured to search for corresponding network information according to the user gender corresponding to the first user identifier, and send the found network information to the first instant messaging client for presentation.

12. The system according to claim 11, wherein the instant messaging server is further configured to acquire a second user identifier used for logging onto the second instant messaging client and corresponding second video data, and send the second video data to the first instant messaging client for displaying;
the gender detection server is further configured to detect a face image in the second video data, and determine a user gender corresponding to the second user identifier according to the face image; and
the information push server is further configured to search for corresponding network information according to the user gender corresponding to the second user identifier, and send the found network information to the second instant messaging client for presentation.
